(19) United States
(12) Patent Application Publication
(10) Pub. No.: US 2026/0112328 A1
(43) Pub. Date: Apr. 23, 2026

(54) DRIVING METHOD FOR DISPLAY DEVICE AND DISPLAY DEVICE

(71) Applicant: HKC CORPORATION LIMITED, Shenzhen (CN)

(72) Inventors: BIN QIU, Shenzhen (CN); Pei XU, Shenzhen (CN)

(21) Appl. No.: 19/344,265

(22) Filed: Sep. 29, 2025

(30) Foreign Application Priority Data
Oct. 17, 2024 (CN) 202411452958.4

(51) Int. Cl. G09G 3/36; G02F 1/133; G02F 1/1333; G02F 1/1368; G09G 3/20

(52) U.S. Cl. CPC G09G 3/3648; G09G 3/2007; G02F 1/13306; G02F 1/133302; G02F 1/1368; G09G 2310/06; G09G 2330/02

(57) ABSTRACT

A driving method for a display device and a display device, the driving method including: predicting a grayscale change value of a data line inside a display panel; obtaining an original voltage waveform of a pre-output of a zero-potential reference point to a trace of a glass substrate; generating a compensation voltage waveform of the zero-potential reference point based on the original voltage waveform of the zero-potential reference point, the grayscale change value, and a first grayscale compensation table; synthesizing the original voltage waveform and the compensation voltage waveform of the zero-potential reference point to output to the trace of the glass substrate.

### CROSS REFERENCE TO RELATED APPLICATIONS

This application claims the priority and benefit of Chinese patent application number 2024114529584, titled “DRIVING METHOD FOR DISPLAY DEVICE AND DISPLAY DEVICE” and filed on Oct. 17, 2024 with China National Intellectual Property Administration, the entire contents of which are incorporated herein by reference.

### TECHNICAL FIELD

The present application relates to the technical field of display, and particularly relates to a driving method for a display device and a display device.

### BACKGROUND

As a flat-panel display device, thin film transistor liquid crystal display (hereinafter referred to as TFT-LCD) is increasingly applied in high-performance display fields due to its characteristics such as small size, low power consumption, no radiation, and relatively low manufacturing cost.

Typically, to reduce costs, a glass substrate is used as a printed circuit board (hereinafter referred as PCB) for the TFT-LCD. When the TFT-LCD performs display, gate lines on a display panel perform progressive scanning row by row to turn on pixel units connected to the gate line of each row, data lines output data signals to the turned-on pixel units to charge the pixel units. When a difference between previous and subsequent grayscale voltages of a pixel is excessively large, and due to high impedance and large parasitic inductance on the glass substrate without capacitance compensation, all current instantaneously draws from a power supply and flows back to a zero-potential reference point (GND), causing significant fluctuations in power voltage or power current supplied to a data driving chip between a display area and a blanking area. Moreover, when switching from a light-load display frame to a heavy-load display frame, or when one row has heavy load while another has light load within the same display frame, power ripple fluctuations vary under similar conditions. Larger draw currents result in greater differences and impacts during heavy-to-light load switching.

### SUMMARY

An objective of embodiments of the present application is to provide a driving method for a display device and a display device, capable of improving a phenomenon of instantaneous large power voltage draw caused by significant load variations in the display device, thereby enhancing stability of display effects of the display device.

Disclosed in the present application is a driving method for a display device, the display device including a display panel and a driving module, in which the driving module includes a timing control board, a glass substrate, and a data driving chip, the timing control board outputs a voltage signal to a trace of the glass substrate, and the voltage signal is converted into a grayscale signal by the data driving chip to be output to the display panel; the driving method includes:
predicting a grayscale change value of a data line inside the display panel;
obtaining an original voltage waveform of a pre-output of a zero-potential reference point to the trace of the glass substrate;
generating a compensation voltage waveform of the zero-potential reference point based on the original voltage waveform of the zero-potential reference point, the grayscale change value, and a first grayscale compensation table; and
synthesizing the original voltage waveform and the compensation voltage waveform of the zero-potential reference point to output to the trace of the glass substrate,
where the original voltage waveform and the compensation voltage waveform of the zero-potential reference point are a pair of inverted waveforms.

Disclosed in the present application is further a display device, including a display panel and a driving module, in which the driving module includes a timing control board, a glass substrate, and a data driving chip, the timing control board outputs a voltage signal of a zero-potential reference point to a trace of the glass substrate, and the voltage signal is converted into a grayscale signal by the data driving chip to be output to the display panel.

The timing control board is provided with a detection module, a memory, and a compensation voltage generation module, the detection module is configured to detect a grayscale change value of a data line input to the display panel, the memory stores a first grayscale compensation table, the compensation voltage generation module generates a compensation voltage waveform of the zero-potential reference point based on the grayscale change value, the first grayscale compensation table stored in the memory, and an original voltage waveform of the zero-potential reference point, and the original voltage waveform and the compensation voltage waveform of the zero-potential reference point are synthesized to output to the trace of the glass substrate.

The present application employs a glass substrate as a circuit board for trace layout. Due to high impedance, large parasitic inductance, and absence of capacitance compensation on the glass substrate, instantaneous power voltage draw becomes substantial, leading to inaccuracy of the voltage of the zero-potential reference point. To address this, the present application first predicts a grayscale change value of a data line inside the display panel, generates a compensation voltage waveform of the zero-potential reference point based on an original voltage waveform of the zero-potential reference point, the grayscale change value, and a first grayscale compensation table, combines the original voltage waveform and the compensation voltage waveform of the zero-potential reference point to output to the trace of the glass substrate, thereby avoiding excessive fluctuation of the voltage of the zero-potential reference point. Consequently, this prevents fluctuations across all voltages that could cause a butterfly effect, avoids impacting the entire power and signal system, resolves the issue of large instantaneous current draw during heavy-to-light load switching by modifying the voltage of the zero-potential reference point ultimately output to the trace of the glass substrate, and maintains stability of the power supply and the voltage of the zero-potential reference point (GND).

### BRIEF DESCRIPTION OF THE DRAWINGS

The included drawings are provided for further understanding of embodiments of the present application, constitute a part of the specification, illustrate embodiments of the present application, and together with the text description, explain principles of the present application. Obviously, the drawings in the following description are merely some embodiments of the present application. For those of ordinary skill in the art, other drawings may be obtained based on these drawings without creative labor. In the drawings:

FIG. 1 is a schematic flow diagram of a driving method according to a first embodiment of the present application;

FIG. 2 is a schematic diagram of exemplary power voltage, power current, and zero-potential reference point voltage signal waveforms of the present application;

FIG. 3 is a schematic diagram of zero-potential reference point voltage signal waveforms according to the first embodiment of the present application;

FIG. 4 is a schematic flow diagram of a driving method according to a second embodiment of the present application;

FIG. 5 is a schematic diagram of power voltage current signals and zero-potential reference point voltage waveforms according to the second embodiment of the present application;

FIG. 6 is a schematic flow diagram of a driving method according to a third embodiment of the present application;

FIG. 7 is a schematic structural diagram of a display device according to a fourth embodiment of the present application;

FIG. 8 is a schematic structural diagram of a driving module according to the fourth embodiment of the present application; and

FIG. 9 is a schematic partial structural diagram of a driving module of a display device according to a fifth embodiment of the present application.

### DETAILED DESCRIPTION OF EMBODIMENTS

It should be understood that the terminology, specific structures, and functional details disclosed herein are merely for describing specific embodiments and are representative. However, the present application may be implemented in many alternative forms and should not be construed as being limited only to the embodiments set forth herein.

The present application is described in detail below with reference to the drawings and optional embodiments.

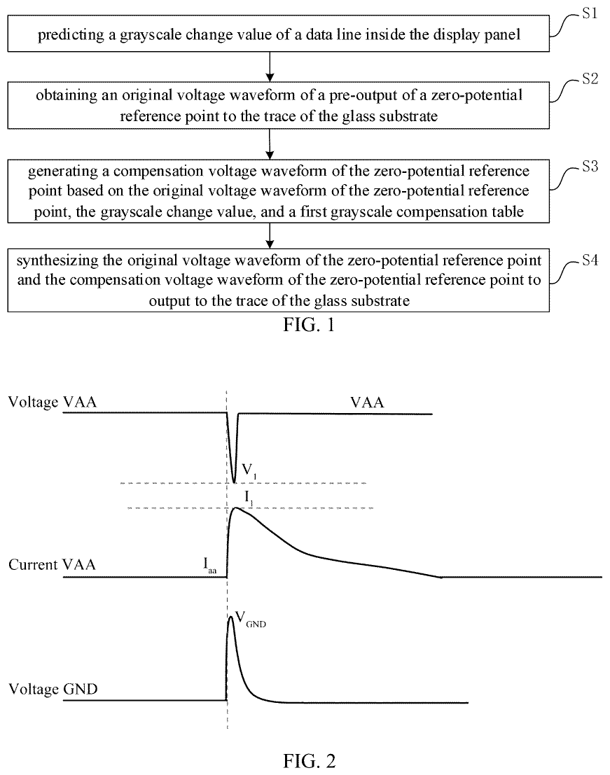

As shown in FIG. 1, as a first embodiment of the present application, to address power voltage instability caused by significant load variations, a driving method for a display device is disclosed. The display device includes a display panel and a driving module, the driving module includes a timing control board, a glass substrate, and a data driving chip. The timing control board outputs a voltage signal to a trace of the glass substrate, and the voltage signal is converted into a grayscale signal by the data driving chip to be output to the display panel. The driving method includes:
S1: predicting a grayscale change value of a data line inside the display panel;
S2: obtaining an original voltage waveform of a pre-output of a zero-potential reference point to the trace of the glass substrate;
S3: generating a compensation voltage waveform of the zero-potential reference point based on the original voltage waveform of the zero-potential reference point, the grayscale change value, and a first grayscale compensation table; and
S4: synthesizing the original voltage waveform of the zero-potential reference point and the compensation voltage waveform of the zero-potential reference point to output to the trace of the glass substrate,
where the original voltage waveform and the compensation voltage waveform of the zero-potential reference point are a pair of inverted waveforms. A voltage of the compensation voltage waveform falls when a voltage of the original voltage waveform rises; conversely, the voltage of the compensation voltage waveform rises when the voltage of the original voltage waveform falls.

As shown in FIG. 2, which is an actual voltage test diagram of light-load switching to heavy-load when the glass substrate serves as a PCB between a timing control board and a chip-on-film of the display device, three waveform lines in the figure, from top to bottom, represent a power voltage waveform, a power current waveform, and a zero-potential reference point voltage waveform, respectively. Under normal conditions, the power voltage is a stable voltage source waveform, a voltage value is stable at VAA with almost no visible fluctuation. Therefore, this power voltage is usually represented by VAA, a power trace is referred to as a VAA trace, and a resistance of the power trace is represented by Rᵥₐₐ. At the instant of screen switching, current required by a backend load suddenly increases. However, a power supply chip is not able to react instantly at this moment. With constant provided power, the power voltage suddenly drops from VAA to V₁ (V₁<VAA), while the power current abruptly reaches I₁ (I₁>Iₐₐ). During the extremely short period before and after this change, power before the change equals power after the change, thus Iₐₐ×VAA≈I₁×V₁. Subsequently, the power supply adjusts its output to restore the power voltage to VAA, with the power current outputting Iₐₐ according to actual demand. Due to this instantaneous current draw and the presence of trace impedance and parasitic inductance in GND, when circuit switches are suddenly opened or closed, internal overvoltage occurs. This generates spike currents within the circuit over a short duration, causing the voltage value of the zero-potential reference point on the glass PCB to instantaneously rise to V_{GND}. Based on this, the present application first predicts a grayscale change value of a data line inside the display panel, generates a compensation voltage waveform of the zero-potential reference point based on an original voltage waveform of the zero-potential reference point, the grayscale change value, and a first grayscale compensation table, combines the original voltage waveform and the compensation voltage waveform of the zero-potential reference point to output to the trace of the glass substrate. This avoids excessive fluctuation of the voltage of the zero-potential reference point, thereby preventing voltage fluctuations across all systems that could cause a butterfly effect and impact the entire power and signal system. By modifying the voltage of the zero-potential reference point ultimately output to the trace of the glass substrate, the issue of large instantaneous current draw during heavy-to-light load switching is resolved, stability of the power supply and the voltage of the zero-potential reference point (GND) is maintained, and abnormalities in Gamma voltage levels caused by excessive V_{GND} fluctuations are prevented.

Generally, referring to FIG. 3, a rising time of a voltage in the original voltage waveform of the zero-potential reference point coincides with a falling time of a voltage in the compensation voltage waveform of the zero-potential reference point, a rising duration of the voltage in the original voltage waveform of the zero-potential reference point equals to a falling duration of the voltage in the compensation voltage waveform of the zero-potential reference point, a falling time of the voltage in the original voltage waveform of the zero-potential reference point coincides with a rising time of a voltage in the compensation voltage waveform of the zero-potential reference point, a falling duration of the voltage in the original voltage waveform of the zero-potential reference point equals to a rising duration of the voltage in the compensation voltage waveform of the zero-potential reference point.

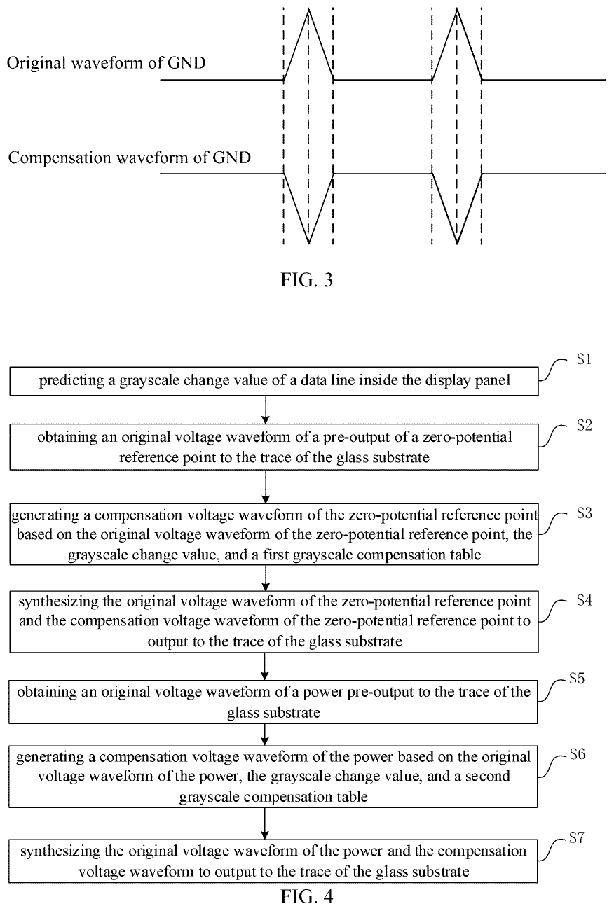

As shown in FIG. 4, as a second embodiment of the present application, which further refines and improves upon the aforementioned first embodiment. Considering that output power voltage may still cause current draw issues after adjusting the voltage of the zero-potential reference point, this embodiment additionally adjusts the power voltage. Specifically, the driving method further includes the following steps:
S5: obtaining an original voltage waveform of a power pre-output to the trace of the glass substrate;
S6: generating a compensation voltage waveform of the power based on the original voltage waveform of the power, the grayscale change value, and a second grayscale compensation table; and
S7: synthesizing the original voltage waveform of the power and the compensation voltage waveform to output to the trace of the glass substrate,
where the original voltage waveform and the compensation voltage waveform of the power are a pair of inverted waveforms.

This embodiment also compensates the power voltage by either compensating for ripple fluctuations caused by instantaneous current draw issues at various voltage sources or slowing the rise slope. This resolves the issue of large instantaneous current draw during heavy-to-light load switching and maintains stability of the power supply and GND.

Further, it should be noted that step S2 includes:
S21: collecting an actual voltage of the zero-potential reference point on the data driving chip, converting the collected actual voltage into a digital signal voltage, and storing the digital signal voltage in a storage table;
S22: generating, based on the digital signal voltage stored in the storage table, a corresponding analog voltage of the zero-potential reference point; and
S23: obtaining, based on the analog voltage of the zero-potential reference point, the original voltage waveform of the pre-output of the zero-potential reference point to the trace of the glass substrate;

Step S6 includes:
S61: collecting an actual voltage of the power on the data driving chip, converting the collected actual voltage into a digital signal voltage, and storing the digital signal voltage in the storage table;
S62: generating a corresponding analog voltage of the power based on the digital signal voltage stored in the storage table; and
S63: obtaining, based on the analog voltage of the power, the original voltage waveform of the pre-output of the zero-potential reference point to the trace of the glass substrate.

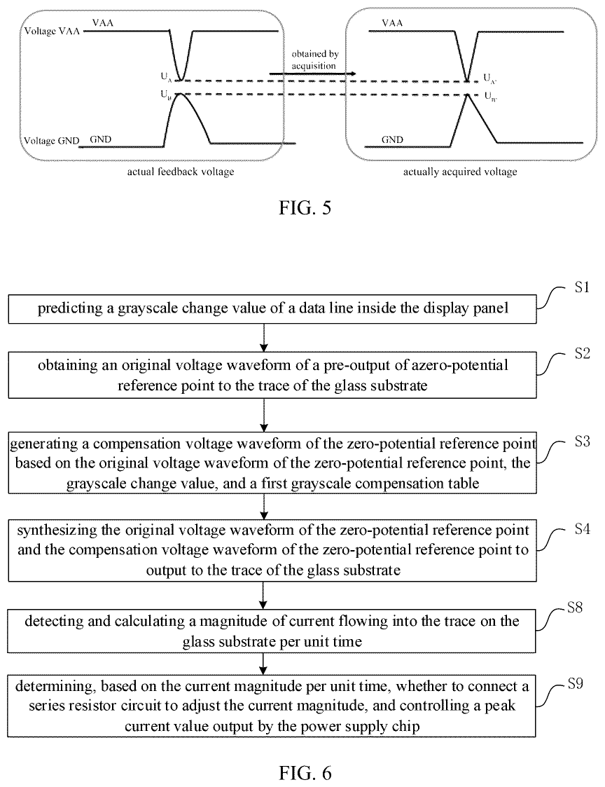

By collecting the voltage of the distal zero-potential reference point and power voltage back to the timing control board, specifically through independent traces on the glass PCB that do not overlap with other traces or connect to large-area power voltage traces entering the data driving chip (to avoid interference from other factors). This is equivalent to pulling a feedback signal back to the acquisition module. The collected signal, as shown by the actual feedback voltage in FIG. 5, reveals an actual voltage waveform that is not uniformly or regularly rising. For the acquisition module, accurate analog waveform capture is unattainable. Thus, an acquired actual power voltage waveform is obtained after processing by the acquisition module. Typically, analog voltage is converted to digital voltage for storage. The corresponding digital voltage can be directly retrieved to derive the voltage of the original voltage waveform when the timing control board subsequently outputs power voltage and the voltage of the zero-potential reference point. Compensation voltage for the corresponding compensation voltage waveform is generated from the digital voltage to synthesize the power voltage and voltage of the zero-potential reference point.

Referring to FIG. 5, the waveform of the actual feedback voltage represents the power voltage and zero-potential reference point voltage waveforms at the distal end of the glass PCB trace before entering the data driving chip. Collection requires pulling the power line and zero-potential reference point trace from the glass PCB back to the acquisition module. Due to high resistance, attenuation occurs, resulting in a voltage drop in the actually acquired voltage. Consequently, voltage values at points A and B are both greater than those at points A′ and B′. However, the attenuation effect should also be considered since the final compensated waveform is transmitted back to the power supply. Thus, U_{A′}=U_{A}−Rᵥₐₐ×Iᵥₐₐ (where Rᵥₐₐ is the resistance value of the power trace on the glass substrate, and Ivaa is the power current value on the power trace of the glass substrate), and U_{B′}=U_{B}−R×Iₜₒₜₐₗ (where R is the resistance value of the zero-potential reference point trace from an input terminal to an output terminal on the glass substrate, Iₜₒₜₐₗ is the sum of current values on all zero-potential reference point traces, and R is the resistance value of the zero-potential reference point trace). Therefore, the voltage drop due to attenuation should be added to the actually acquired voltage, that is, the voltages at points A and B of the compensation voltage waveform are U_{A}=U_{A′}+Rᵥₐₐ×Iᵥₐₐ and U_{B}=U_{B′}+R×Iₜₒₜₐₗ, respectively. Only in this way is the power voltage and GND waveform entering the data driving chip able to be truly restored. Moreover, depending on different grayscales, the current varies, and the positions of points A and B also need to change accordingly.

Generally, the grayscale change value is obtained by acquiring an average grayscale value of a data voltage in a display time and a blanking time of any frame image in the display panel, and calculating a difference between the average grayscale values of the data voltage in the display time and the blanking time to obtain the grayscale change value. Different compensations are invoked corresponding to different grayscale change values, as shown in Table 1 below:

TABLE 1
First Grayscale Compensation Table

| | | | |
|---|---|---|---|
| (1 grayscale to 2 | (1 grayscale to 3 | . . . | (1 grayscale to 255 |
| grayscale) | grayscale) | | grayscale) |
| NA | (2 grayscale to 3 | . . . | (2 grayscale to 255 |
| | grayscale) | | grayscale) |
| NA | NA | (3 grayscale to 4 | (3 grayscale to 255 |
| | | grayscale) | grayscale) |
| NA | NA | NA | (254 grayscale to |
| | | | 255 grayscale) |

The first grayscale compensation table as compensation values corresponding to grayscale change values from 1 to 255 in the step of generating the compensation voltage waveform of the zero-potential reference point based on the original voltage waveform of the zero-potential reference point, the grayscale change value, and the first grayscale compensation table. A corresponding compensation is found regardless of the magnitude of the grayscale change.

Additionally, it should be noted that the compensation values of the first grayscale compensation table and the second grayscale compensation table are different. The first grayscale compensation table compensates for grayscale change values from 1 to 255 grayscales, with compensation values gradually increasing as the grayscale change value increases. The second grayscale compensation table compensates for change values in ranges including 50, 51 to 100, 101 to 150, 151 to 200, and 201 to 250, where compensation values differ across different ranges but remain identical within the same range, as shown in Table 2 below:

TABLE 2
Second Grayscale Compensation Table

| Grayscale Difference | Compensation Value |
|---|---|
| Less than 50 grayscales | No compensation |

| | | |
|---|---|---|
| 51-100 | grayscales | U1 |
| 101-150 | grayscales | U2 |
| 151-200 | grayscales | U3 |
| 201-250 | grayscales | U4 |

Considering that the impact of power voltage on current draw is reduced after improving the GND voltage, and compensation for the power voltage is able to be implemented for grayscale values within specific ranges since GND adjustment allows compensation for every grayscale difference.

As shown in FIG. 6, as a third embodiment of the present application, which is a further improvement on any one of the above embodiments, using the first embodiment as an example for modification, the timing control board is provided with a power supply chip and a plurality of series resistor circuits. The driving method further includes a current inspection and adjustment step, the current inspection and adjustment step includes:
S8: detecting and calculating a magnitude of current flowing into the trace on the glass substrate per unit time;
S9: determining, based on the current magnitude per unit time, whether to connect a series resistor circuit to adjust the current magnitude, and controlling a peak current value output by the power supply chip.

A current adjustment module is provided on the timing control board, the current adjustment module being connected to the power supply chip and configured to regulate spike currents in a power current signal; detecting and calculating a magnitude of current flowing into the trace on the glass substrate per unit time, then selecting a corresponding series resistor circuit to be connected in series into the trace loop, choosing an instant of signal switching as a timing for connecting the resistor in series into the loop, this produces a variation; to reduce a peak current requires increasing a resistance if a voltage difference per unit time is constant. Therefore, the series resistor circuit functions to inhibit a sharp increase in instantaneous current variation, thereby allowing it to rise slowly. After the current stabilizes, the series-connected resistor is removed to restore normal operation mode, resolving the issue of large instantaneous current draw during heavy-to-light load switching, maintaining stability of the power supply and the voltage of the zero-potential reference point GND, and preventing excessive power voltage fluctuations caused by substantial power current variations.

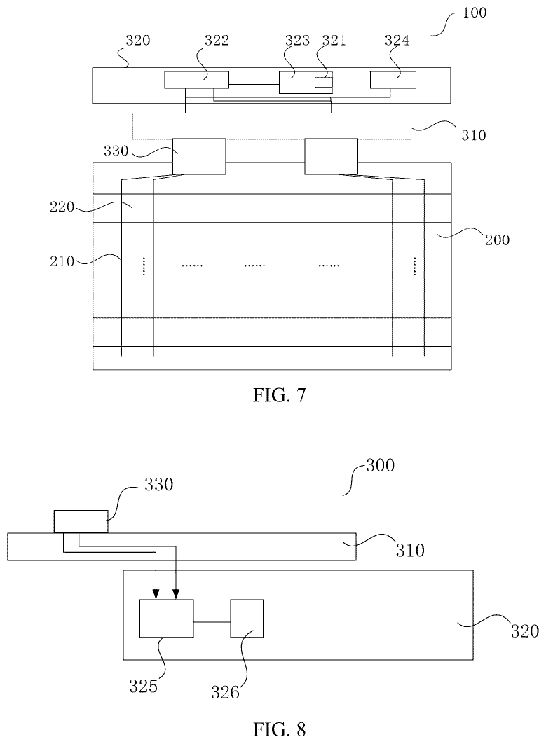

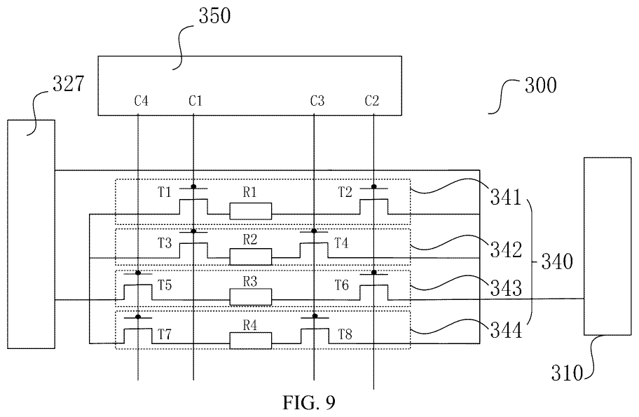

As shown in FIG. 7, as a fourth embodiment of the present application, a display device is disclosed. The display device is driven employing the driving method according to any one of the above embodiments. Referring to FIG. 7 and FIG. 8, the display device 100 includes a driving module 300 and a display panel 200. The driving module 300 includes a timing control board 320, a glass substrate 310, and a data driving chip 330. The timing control board 320 outputs a voltage signal of a zero-potential reference point to a trace of the glass substrate 310, and the voltage signal of the zero-potential reference point is converted into a grayscale signal by the data driving chip 330 to be output to the display panel 200. The timing control board 320 is provided with a detection module 322, a memory 323, and a compensation voltage generation module 324. The detection module 322 is configured to detect a grayscale change value of a data line input to the display panel 200. The memory 323 stores a first grayscale compensation table 321. The compensation voltage generation module 324 generates a compensation voltage waveform of the zero-potential reference point based on the grayscale change value, the first grayscale compensation table 321 stored in the memory 323, and an original voltage waveform of the zero-potential reference point, and the compensation voltage generation module 324 synthesizes the original voltage waveform and the compensation voltage waveform of the zero-potential reference point to output to the trace of the glass substrate 310.

The timing control board 320 is provided with an acquisition module 325 and a digital-to-analog conversion module 326. The acquisition module 325 is configured to acquire a power voltage signal and a zero-potential reference point voltage signal output from the trace of the glass substrate 310 to the data driving chip 330, and send the power voltage signal and the zero-potential reference point voltage signal to the digital-to-analog conversion module 326. The digital-to-analog conversion module 326 converts the acquired power voltage signal and zero-potential reference point voltage signal into digital signals and stores the digital signals in a memory. The digital-to-analog conversion module 326 includes a digital-to-analog converter and an analog-to-digital converter.

The acquisition module 325 collects distal GND voltage and power voltage VAA back to the timing control board 320. Specifically, independent traces are laid on the glass PCB that do not overlap with other traces or connect to large-area VAA or GND traces entering the data driving chip 330. The collected voltage waveform is processed by the acquisition module 325 to obtain an acquired actual voltage waveform. The actual voltage waveform is converted from analog voltage to digital voltage through the digital-to-analog conversion module 326 and stored. Due to different screen images and varying current draws, all compensation voltage waveforms differ. For ripple processing, delay issues occur if the collected signal is reprocessed and re-input to the data driving chip 330. The solution of simply adding capacitors is unsuitable for the glass substrate platform. Therefore, during production of the display panel, a comprehensive database must first be established, encompassing all possible scenarios of light-load switching to heavy-load and heavy-load switching to light-load. This ensures all data is pre-processed before output, enabling synthesis of the original voltage waveform and compensation voltage waveform to prevent current peaks.

As shown in FIG. 9, as a fifth embodiment of the present application, which further refines the aforementioned fourth embodiment. During actual operation, potential issues may arise. The acquisition module 325 may acquire an actually output current. To ensure proper display after adjusting power voltage and GND voltage, a current inspection step is provided. At least four series resistor circuits 340 are provided. A magnitude of current flowing into the trace on the glass substrate 310 per unit time is detected and calculated; whether to connect a series resistor circuit to adjust the current magnitude is determined based on the current magnitude per unit time, and a peak current value output by the power supply chip 328 is controlled.

Specifically, each series resistor circuit 340 is provided with two control switches and one resistor. The resistor in each series resistor circuit 340 is disposed between the two control switches. Control terminals of the two control switches are respectively connected to a selection controller 350. The selection controller outputs different control signals to the two control switches in each series resistor circuit 340 according to a voltage difference calculated by a load calculation module 140, to control the corresponding series resistor circuit 340 to be connected in series to a loop between the power supply chip 328 and the glass substrate 310.

Intervention targets the root cause: transitions in display panel 200 from light-load to heavy-load or vice versa arise from abrupt mutations in data voltage within drive signals. Given fixed trace resistance on glass substrate 310 and constant backend load, a larger voltage difference change per unit time results in greater current. If the voltage difference per unit time is constant, reducing peak current requires increasing resistance. Thus, the series-connected resistor serves to inhibit sharp increases in instantaneous current variation, allowing the power supply output current to rise gradually. After stabilization, the series-connected resistor is removed to restore normal operation mode.

In some embodiments, four series resistor circuits 340 are provided, the four series resistor circuits 340 being a first series resistor circuit 341, a second series resistor circuit 342, a third series resistor circuit 343, and a fourth series resistor circuit 344; the first series resistor circuit 341 includes a first control switch T1, a second control switch T2, and a first resistor R1, a control terminal of the first control switch T1 receives a first control signal C1, an input terminal of the first control switch T1 is connected to the power supply chip 328, an output terminal of the first control switch T1 is connected to an input terminal of the second control switch T2 through the first resistor R1, a control terminal of the second control switch T2 receives a second control signal C2, an output terminal of the second control switch T2 is connected to the trace on the glass substrate 310; the second series resistor circuit 342 includes a third control switch T3, a fourth control switch T4, and a second resistor R2, a control terminal of the third control switch T3 receives the first control signal C1, an input terminal of the third control switch T3 is connected to the power supply chip 328, an output terminal of the third control switch T3 is connected to an input terminal of the fourth control switch T4 through the second resistor R2, a control terminal of the fourth control switch T4 receives a third control signal C3, an output terminal of the fourth control switch T4 is connected to the trace on the glass substrate 310; the third series resistor circuit 343 includes a fifth control switch T5, a sixth control switch T6, and a third resistor R3, a control terminal of the fifth control switch T5 receives a fourth control signal C4, an input terminal of the fifth control switch T5 is connected to the power supply chip 328, an output terminal of the fifth control switch T5 is connected to an input terminal of the sixth control switch T6 through the third resistor R3, a control terminal of the sixth control switch T6 receives the second control signal C2, an output terminal of the sixth control switch T6 is connected to the trace on the glass substrate 310; the fourth series resistor circuit 344 includes a seventh control switch T7, an eighth control switch T8, and a fourth resistor R4, a control terminal of the seventh control switch T7 receives the fourth control signal C4, an input terminal of the seventh control switch T7 is connected to the power supply chip 328, an output terminal of the seventh control switch T7 is connected to an input terminal of the eighth control switch T8 through the fourth resistor R4, a control terminal of the eighth control switch T8 receives the third control signal C3, an output terminal of the eighth control switch T8 is connected to the trace on the glass substrate 310. Resistance values of the first resistor R1, the second resistor R2, the third resistor R3, and the fourth resistor R4 increase sequentially. Current output by the power supply chip 328 is altered after passing through resistors in the series resistor circuit, to be output to the trace of the glass substrate 310 and ultimately input into the display panel 200. Based on a load magnitude fed back by the display panel 200, a resistance value in the series resistor circuit and a grayscale range value are able to be adjusted.

It should be noted that limitations of various steps in this solution do not prescribe a sequential order of steps, provided such order does not affect implementation of the specific solution. That is, steps written earlier may be executed first, executed later, or even executed simultaneously. As long as this solution can be implemented, all such variations shall be considered within the protection scope of the present application. The inventive concept of the present application may form numerous embodiments. However, due to limited space in the application documents, not all are able to be exhaustively listed. Therefore, without conflicting premises, the described embodiments or technical features may be arbitrarily combined to form new embodiments. After combination of embodiments or technical features, original technical effects will be enhanced.

The above content provides further detailed explanations of the present application with reference to specific optional implementations, but it should not be construed that specific implementations of the present application are limited to these descriptions. For those of ordinary skill in the technical field of the present application, without departing from the inventive concept, several simple deductions or substitutions may be made, all of which shall be regarded as falling within the protection scope of the present application.

What is claimed is:

1. A driving method for a display device, the display device comprising a display panel and a driving module, wherein the driving module comprises a timing control board, a glass substrate, and a data driving chip, the timing control board outputs a voltage signal to a trace of the glass substrate, and the voltage signal is converted into a grayscale signal by the data driving chip to be output to the display panel; the driving method comprising:
predicting a grayscale change value of a data line inside the display panel;
obtaining an original voltage waveform of a pre-output of a zero-potential reference point to the trace of the glass substrate;
generating a compensation voltage waveform of the zero-potential reference point based on the original voltage waveform of the zero-potential reference point, the grayscale change value, and a first grayscale compensation table; and
synthesizing the original voltage waveform of the zero-potential reference point and the compensation voltage waveform of the zero-potential reference point to output to the trace of the glass substrate,
wherein the original voltage waveform and the compensation voltage waveform of the zero-potential reference point are a pair of inverted waveforms.

2. The driving method according to claim 1, wherein the driving method further comprises:
obtaining an original voltage waveform of a power pre-output to the trace of the glass substrate;
generating a compensation voltage waveform of the power based on the original voltage waveform of the power, the grayscale change value, and a second grayscale compensation table; and
synthesizing the original voltage waveform of the power and the compensation voltage waveform to output to the trace of the glass substrate,
wherein the original voltage waveform and the compensation voltage waveform of the power are a pair of inverted waveforms.

3. The driving method according to claim 2, wherein the obtaining the original voltage waveform of the pre-output of the zero-potential reference point to the trace of the glass substrate comprises:
collecting an actual voltage of the zero-potential reference point on the data driving chip, converting the collected actual voltage into a digital signal voltage, and storing the digital signal voltage in a storage table;
generating, based on the digital signal voltage stored in the storage table, a corresponding analog voltage of the zero-potential reference point; and
obtaining, based on the analog voltage of the zero-potential reference point, the original voltage waveform of the pre-output of the zero-potential reference point to the trace of the glass substrate,
wherein the obtaining the original voltage waveform of the power pre-output to the trace of the glass substrate comprises:
collecting an actual voltage of the power on the data driving chip, converting the collected actual voltage into a digital signal voltage, and storing the digital signal voltage in the storage table;
generating a corresponding analog voltage of the power based on the digital signal voltage stored in the storage table; and
obtaining, based on the analog voltage of the power, the original voltage waveform of the pre-output of the zero-potential reference point to the trace of the glass substrate.

4. The driving method according to claim 3, wherein a resistance value of a power trace on the glass substrate is Rᵥₐₐ, a power current value on the power trace of the glass substrate is Iᵥₐₐ, a sum of current values of all zero-potential reference point traces is Iₜₒₜₐₗ, an absolute value of a spike voltage value in the compensation voltage waveform of the power is U_{A}, an absolute value of a collected spike voltage value of the power is U_{A′}, an absolute value of a spike voltage value in the compensation voltage waveform of the zero-potential reference point is U_{B}, an absolute value of a collected spike voltage value of the zero-potential reference point is U_{B′}, a resistance value of the zero-potential reference point trace is R,
wherein the absolute value of the spike voltage value in the compensation voltage waveform of the power U_{A}=U_{A′}+Rᵥₐₐ×Iᵥₐₐ, the absolute value of the spike voltage value in the compensation voltage waveform of the zero-potential reference point U_{B}=U_{B′}+R×Iₜₒₜₐₗ.

5. The driving method according to claim 1, wherein the predicting the grayscale change value of the data line inside the display panel comprises:
obtaining an average grayscale value of a data voltage in a display time and a blanking time of any frame image in the display panel; and
calculating a difference between the average grayscale values of the data voltage in the display time and the blanking time, so as to obtain the grayscale change value.

6. The driving method according to claim 1, wherein the first grayscale compensation table has compensation values corresponding to grayscale change values from 1 to 255 in the step of generating the compensation voltage waveform of the zero-potential reference point based on the original voltage waveform of the zero-potential reference point, the grayscale change value, and a first grayscale compensation table.

7. The driving method according to claim 1, wherein a rising time of a voltage in the original voltage waveform of the zero-potential reference point coincides with a falling time of a voltage in the compensation voltage waveform of the zero-potential reference point, a rising duration of the voltage in the original voltage waveform of the zero-potential reference point equals to a falling duration of the voltage in the compensation voltage waveform of the zero-potential reference point, a falling time of the voltage in the original voltage waveform of the zero-potential reference point coincides with a rising time of a voltage in the compensation voltage waveform of the zero-potential reference point, a falling duration of the voltage in the original voltage waveform of the zero-potential reference point equals to a rising duration of the voltage in the compensation voltage waveform of the zero-potential reference point.

8. The driving method according to claim 4, wherein a rising time of a voltage in the original voltage waveform of the zero-potential reference point coincides with a falling time of a voltage in the compensation voltage waveform of the zero-potential reference point, a rising duration of the voltage in the original voltage waveform of the zero-potential reference point equals to a falling duration of the voltage in the compensation voltage waveform of the zero-potential reference point, a falling time of the voltage in the original voltage waveform of the zero-potential reference point coincides with a rising time of a voltage in the compensation voltage waveform of the zero-potential reference point, a falling duration of the voltage in the original voltage waveform of the zero-potential reference point equals to a rising duration of the voltage in the compensation voltage waveform of the zero-potential reference point.

9. The driving method according to claim 3, wherein compensation values of the first grayscale compensation table and the second grayscale compensation table are different, the first grayscale compensation table compensates for grayscale change values from 1 to 255 grayscales, and the compensation values of the first grayscale compensation table increases gradually as the grayscale change value increases.

10. The driving method according to claim 3, wherein the second grayscale compensation table provides compensation with different magnitudes for grayscale change values in ranges of 50, 51 to 100, 101 to 150, 151 to 200, and 201 to 250, provides no compensation for grayscale change values less than 50, wherein compensation values differ across different ranges and remain identical within the same range.

11. The driving method according to claim 2, wherein the timing control board is provided with a power supply chip and a plurality of series resistor circuits, the driving method further comprises a current inspection and adjustment step, the current inspection and adjustment step comprises:
detecting and calculating a magnitude of current flowing into the trace on the glass substrate per unit time; and
determining, based on the current magnitude per unit time, whether to connect a series resistor circuit to adjust the current magnitude, and controlling a peak current value output by the power supply chip.

12. The driving method according to claim 11, wherein the determining, based on the current magnitude per unit time, whether to connect the series resistor circuit to adjust the current magnitude and controlling the peak current value output by the power supply chip comprises:
detecting and calculating a magnitude of current flowing into the trace on the glass substrate per unit time;
selecting a corresponding series resistor circuit to be connected in series into the trace loop; and
choosing an instant of signal switching as a timing for connecting the resistor in series into the loop,
wherein to reduce a peak current requires increasing a resistance if a voltage difference per unit time is constant.

13. A display device, comprising a display panel and a driving module, wherein the driving module comprises a timing control board, a glass substrate, and a data driving chip, the timing control board outputs a voltage signal of a zero-potential reference point to a trace of the glass substrate, and the voltage signal of the zero-potential reference point is converted into a grayscale signal by the data driving chip to be output to the display panel;
wherein the timing control board is provided with a detection module, a memory, and a compensation voltage generation module, the detection module is configured to detect a grayscale change value of a data line input to the display panel, the memory stores a first grayscale compensation table, the compensation voltage generation module generates a compensation voltage waveform of the zero-potential reference point based on the grayscale change value, the first grayscale compensation table stored in the memory, and an original voltage waveform of the zero-potential reference point, and the original voltage waveform and the compensation voltage waveform of the zero-potential reference point are synthesized to output to the trace of the glass substrate.

14. The display device according to claim 13, wherein the display device is driven using a driving method, the driving method comprises:
detecting, by the detection module, the grayscale change value of the data line inside the display panel;
obtaining, by the compensation voltage generation module, an original voltage waveform of a pre-output of a zero-potential reference point to the trace of the glass substrate;
generating, by the compensation voltage generation module, a compensation voltage waveform of the zero-potential reference point based on the original voltage waveform of the zero-potential reference point, the grayscale change value, and a first grayscale compensation table; and
synthesizing, by the compensation voltage generation module, the original voltage waveform of the zero-potential reference point and the compensation voltage waveform of the zero-potential reference point to output to the trace of the glass substrate,
wherein the original voltage waveform and the compensation voltage waveform of the zero-potential reference point are a pair of inverted waveforms.

15. The display device according to claim 14, wherein the timing control board is provided with an acquisition module and a digital-to-analog conversion module, the acquisition module is configured to acquire a power voltage signal output from the trace of the glass substrate to the data driving chip, and send the power voltage signal to the digital-to-analog conversion module, the digital-to-analog conversion module converts an acquired voltage signal of the zero-potential reference point into a digital signal and stores the digital signal in a memory.
the obtaining the original voltage waveform of the pre-output of the zero-potential reference point to the trace of the glass substrate comprises:
collecting an actual voltage of the zero-potential reference point on the data driving chip, converting the collected actual voltage into a digital signal voltage, and storing the digital signal voltage in a storage table;
generating, based on the digital signal voltage stored in the storage table, a corresponding analog voltage of the zero-potential reference point; and
obtaining, based on the analog voltage of the zero-potential reference point, the original voltage waveform of the pre-output of the zero-potential reference point to the trace of the glass substrate.

16. The display device according to claim 15, wherein the timing control board is provided with a power supply chip and a plurality of series resistor circuits, the driving method further comprises a current inspection and adjustment step, the current inspection and adjustment step comprises:
detecting and calculating a magnitude of current flowing into the trace on the glass substrate per unit time; and
determining, based on the current magnitude per unit time, whether to connect a series resistor circuit to adjust the current magnitude, and controlling a peak current value output by the power supply chip.

17. The display device according to claim 13, wherein the timing control board is provided with an acquisition module and a digital-to-analog conversion module, the acquisition module is configured to acquire a power voltage signal and a zero-potential reference point voltage signal output from the trace of the glass substrate to the data driving chip, and send the power voltage signal and the zero-potential reference point voltage signal to the digital-to-analog conversion module, the digital-to-analog conversion module converts the acquired power voltage signal and zero-potential reference point voltage signal into digital signals and stores the digital signals in the memory.

18. The display device according to claim 16, wherein each series resistor circuit is provided with two control switches and one resistor, the resistor in each series resistor circuit is disposed between the two control switches, control terminals of the two control switches are respectively connected to a selection controller, the selection controller outputs different control signals to the two control switches in each series resistor circuit according to a voltage difference calculated by a load calculation module, to control the corresponding series resistor circuit to be connected in series to a loop between the power supply chip and the glass substrate.

19. The display device according to claim 18, wherein four series resistor circuits are provided, the four series resistor circuits being a first series resistor circuit, a second series resistor circuit, a third series resistor circuit, and a fourth series resistor circuit; the first series resistor circuit comprises a first control switch, a second control switch, and a first resistor, a control terminal of the first control switch receives a first control signal, an input terminal of the first control switch is connected to the power supply chip, an output terminal of the first control switch is connected to an input terminal of the second control switch through the first resistor, a control terminal of the second control switch receives a second control signal, an output terminal of the second control switch is connected to the trace on the glass substrate; the second series resistor circuit comprises a third control switch, a fourth control switch, and a second resistor, a control terminal of the third control switch receives the first control signal, an input terminal of the third control switch is connected to the power supply chip, an output terminal of the third control switch is connected to an input terminal of the fourth control switch through the second resistor, a control terminal of the fourth control switch receives a third control signal, an output terminal of the fourth control switch is connected to the trace on the glass substrate; the third series resistor circuit comprises a fifth control switch, a sixth control switch, and a third resistor, a control terminal of the fifth control switch receives a fourth control signal, an input terminal of the fifth control switch is connected to the power supply chip, an output terminal of the fifth control switch is connected to an input terminal of the sixth control switch through the third resistor, a control terminal of the sixth control switch receives the second control signal, an output terminal of the sixth control switch is connected to the trace on the glass substrate; the fourth series resistor circuit comprises a seventh control switch, an eighth control switch, and a fourth resistor, a control terminal of the seventh control switch receives the fourth control signal, an input terminal of the seventh control switch is connected to the power supply chip, an output terminal of the seventh control switch is connected to an input terminal of the eighth control switch through the fourth resistor, a control terminal of the eighth control switch receives the third control signal, an output terminal of the eighth control switch is connected to the trace on the glass substrate.

20. The display device according to claim 19, wherein resistance values of the first resistor, the second resistor, the third resistor, and the fourth resistor increase sequentially.
